(19) United States
(12) Patent Application Publication
(10) Pub. No.: US 2026/0084764 A1
(43) Pub. Date: Mar. 26, 2026

(54) STOWABLE WHEEL TRAILER HITCH

(71) Applicant: Ford Global Technologies, LLC, Dearborn, MI (US)

(72) Inventors: Michael John Harmon, Northville, MI (US); Hussain Z. Tajmahal, Detroit, MI (US); Matthew Craddock, Dearborn, MI (US)

(21) Appl. No.: 18/890,864

(22) Filed: Sep. 20, 2024

(51) Int. Cl. B62D 53/08

(52) U.S. Cl. CPC B62D 53/0828

(57) ABSTRACT

A system and method comprise selectively moving a trailer hitch between a towing position where the trailer hitch is located in a cargo area above a vehicle bed floor and a stowed position where the trailer hitch is located underneath the bed floor and hidden from view.

### TECHNICAL FIELD

This disclosure relates generally to a trailer hitch mounted to a truck bed, and more particularly to a trailer hitch that is moveable between a use position and storage position.

### BACKGROUND

Vehicles often include a hitch that is used to tow trailers, boats, or another vehicle. One type of hitch is referred to as a fifth-wheel trailer hitch. This type of hitch is mounted within an open truck bed area and may take up a significant portion of available cargo space.

### SUMMARY

A system according to an exemplary aspect of the present disclosure includes, among other things: a bed floor including a hitch opening; a platform mounted to cover the hitch opening, the platform having a first bed surface and a second bed surface facing opposite the first bed surface; and a hitch supported on the first bed surface of the platform, wherein the platform and the hitch are selectively movable as a unit between a towing position where the hitch is located in a cargo area above the bed floor and a stowed position where the hitch is located underneath the bed floor.

In a further non-limiting embodiment of any system, the first bed surface is flush with an upper surface of the bed floor when in the towing position and the second bed surface is flush with the upper surface of the bed floor when in the stowed position.

In a further non-limiting embodiment of any system, an actuator is selectively controlled to move the unit between the towing position and the stowed position.

In a further non-limiting embodiment of any system, the actuator comprises a lever arm that is coupled to a drive mechanism that interconnects the lever arm and the unit.

In a further non-limiting embodiment of any system, the bed floor includes a first receptacle extending underneath the bed floor, wherein the lever arm is received within the first receptacle and covered with a cap when the unit is in the stowed position.

In a further non-limiting embodiment of any system, a second receptacle is supported by a vehicle frame structure underneath the bed floor and has an open end aligned with the hitch opening, and wherein the second receptacle is spaced apart and separate from the first receptacle.

In a further non-limiting embodiment of any system, the unit is rotatable relative to the bed floor between the towing position and the stowed position.

In a further non-limiting embodiment of any system, a pivot rod is coupled to the unit to support the unit relative to a vehicle frame for pivoting movement between the towing position and the stowed position.

In a further non-limiting embodiment of any system, at least one lock member is moveable between a lock position where the unit is prevented from moving relative to the bed floor and an unlock position where the unit is allowed to move relative to the bed floor.

In a further non-limiting embodiment of any system, the at least one lock member comprises at least one locking tooth associated with the bed floor along an edge of the hitch opening and at least one locking slot formed in an outer edge of the platform that receives the at least one locking tooth when in the lock position.

In a further non-limiting embodiment of any system, the at least one locking tooth is coupled for rotation with a shaft supported by the bed floor.

A system according to an exemplary aspect of the present disclosure includes, among other things: a bed floor defining a cargo area and including a hitch opening; a receptacle supported by a vehicle frame underneath the bed floor and having an open end aligned with the hitch opening; a platform mounted to cover the open end of the receptacle, the platform having a first bed surface and a second bed surface facing opposite the first bed surface; and a hitch supported on the first bed surface of the platform, wherein the platform and the hitch are selectively movable as a unit between a towing position where the hitch is located in the cargo area and a stowed position where the hitch is received within the receptacle and the second bed surface faces the cargo area.

In a further non-limiting embodiment of any system, the first bed surface is flush with an upper surface of the bed floor when in the towing position and the second bed surface is flush with the upper surface of the bed floor when in the stowed position.

In a further non-limiting embodiment of any system, a lever arm is coupled to a drive mechanism that interconnects the lever arm and the unit.

In a further non-limiting embodiment of any system, the unit is rotatable relative to the bed floor between the towing position and the stowed position via selective movement of the lever arm.

In a further non-limiting embodiment of any system, a first set of locking teeth is associated with the bed floor along one edge of the hitch opening and a second set of locking teeth is associated with the bed floor along an opposite edge of the hitch opening, and including a first set of locking slots formed in a first outer edge of the platform and a second set of locking slots formed in a second outer edge of the platform that is opposite of the first outer edge, and wherein the first set of locking teeth are received within the first set of locking slots and the second set of locking teeth are received within the second set of locking slots when in the unit is in a lock position.

In a further non-limiting embodiment of any system, the receptacle comprises an enclosed tub extending underneath the bed floor from the open end, and wherein the enclosed tub includes at least one drain opening.

A method according to an exemplary aspect of the present disclosure includes, among other things: selectively moving a trailer hitch between a towing position where the trailer hitch is located in a cargo area above a vehicle bed floor and a stowed position where the trailer hitch is located underneath the vehicle bed floor and hidden from view.

In a further non-limiting embodiment of any method, the method includes rotating the trailer hitch between the towing position and the stowed position.

In a further non-limiting embodiment of any method, the method includes: locking the trailer hitch relative to the vehicle bed floor when trailer hitch is in the towing position; unlocking the trailer hitch; rotating the trailer hitch to the stowed position; and relocking the trailer hitch to the vehicle bed floor.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a top perspective view of a truck with a cargo bed supporting a unit comprising a trailer hitch and associated platform assembly in a towing position.

FIG. 2 is similar to FIG. 1 but shows the unit in a storage position.

FIG. 3 is a top perspective view of the trailer hitch of FIG. 1 moving between the towing and storage positions.

FIG. 4 is similar to FIG. 3 but shows a locking connection structure of a locking edge of a hitch support platform and a locking edge of a cargo bed floor.

FIG. 5 is a top perspective view of the unit in relation to a vehicle frame structure.

FIG. 6 is a side view of FIG. 5.

FIG. 7 is a top view of the cargo bed floor with the unit removed to show a drain.

FIG. 8 illustrates an example of a two-way ratchet mechanism.

### DETAILED DESCRIPTION

This disclosure details a system and method that comprise selectively moving a trailer hitch between a towing position where the trailer hitch is located in a cargo area above a vehicle bed floor and a stowed position where the trailer hitch is located underneath the bed floor and hidden from view.

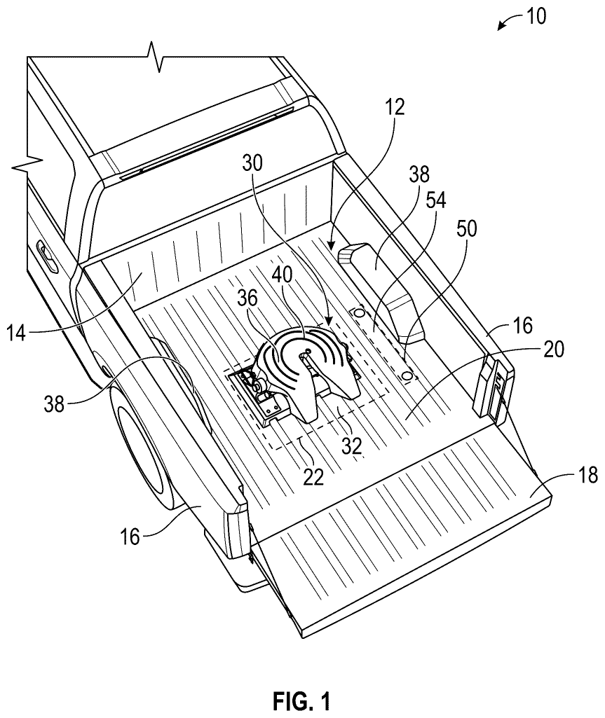

FIG. 1 illustrates a vehicle 10 with a cargo area 12 defined by a forward wall 14, two side walls 16, and a tailgate 18 that is movable between an open position and a closed position. The cargo area 12 has a bed floor 20 that is used to support cargo.

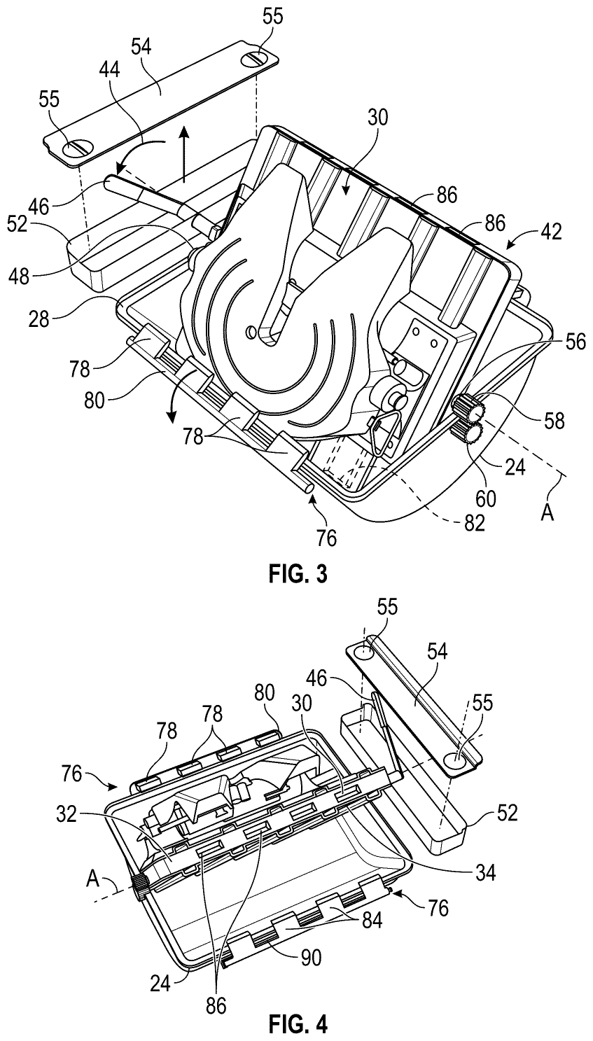

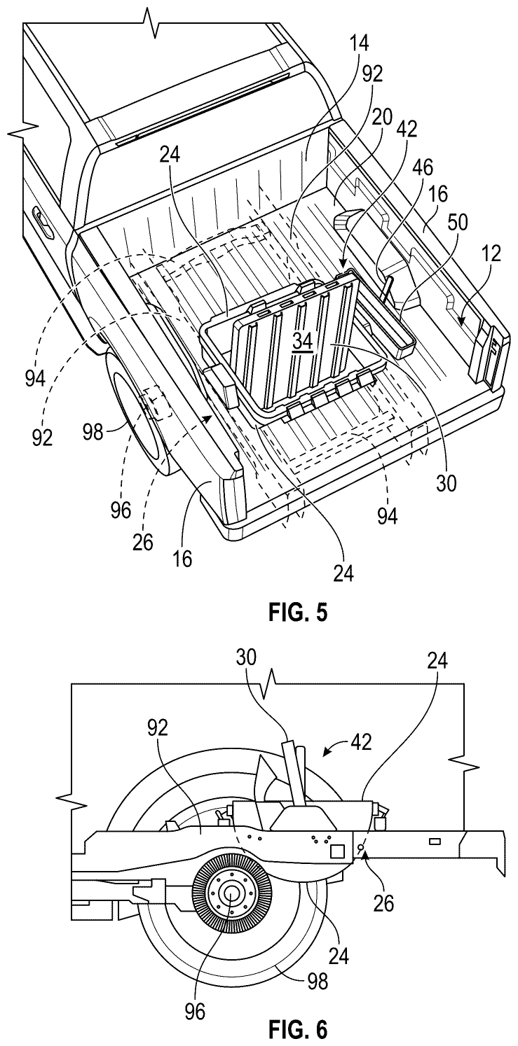

In implementations, the bed floor 20 includes a hitch opening 22 and a receptacle 24 is supported by a vehicle frame 26 underneath the bed floor 20 as shown in FIGS. 5-6. The receptacle 24 has an open end 28 (FIG. 3) that is aligned with the hitch opening 22.

In implementations, a platform 30 fits within the hitch opening 22 and is mounted to cover the open end 28 of the receptacle 24. The platform 30 has a first bed surface 32 and a second bed 34 surface facing opposite the first bed surface 32. The bed surfaces 32, 34 provide a continuous and uninterrupted bed geometry on both sides of the platform 30.

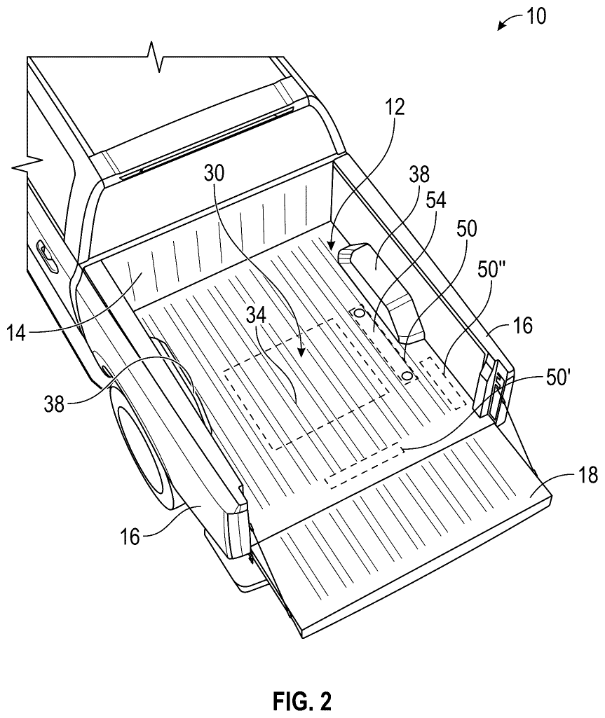

In implementations, a hitch 40 is supported on the first bed surface 32 of the platform 30 such that the platform 30 and the hitch 40 are selectively movable as a unit 42 (FIG. 3) between a towing position where the hitch 40 is located in the cargo area 12 (FIG. 1), and a stowed position where the hitch 40 is received within the receptacle 24 and the second bed surface 34 faces the cargo area 12 (FIG. 2). In this configuration, when in the towing position, the hitch 40 is located in the cargo area 12 above the bed floor 20, and when in the stowed position, the hitch 40 is located underneath the bed floor 20.

In one example, the hitch 40 comprises a fifth-wheel trailer hitch that is used to connect a large trailer to a tow vehicle, such as the pickup truck 10 shown in FIG. 1. The fifth-wheel hitch mounts in the bed of the truck and uses a large, horizontally-oriented coupling device 36 that provides a more stable and secure connection, distributing a trailer's weight more evenly and reducing sway.

In implementations, the first bed surface 32 is flush with an upper surface of the bed floor 20 when in the towing position and the second bed 34 surface is flush with the upper surface of the bed floor 20 when in the stowed position. This provides for an enlarged planar cargo area and an aesthetically pleasing appearance when the unit 42 is stowed.

In implementations, an actuator 44 (FIG. 3) is selectively controlled/actuated to move the unit 42 between the towing position and the stowed position.

In one example, the actuator 44 comprises a lever arm 46 that is coupled to a drive mechanism 48 that interconnects the lever arm 46 and the unit 42.

In implementations, the bed floor 20 includes an additional opening 50 that receives another receptacle 52 extending underneath the bed floor 20. The receptacle 52 defines an open area or cavity for the lever arm and separates access to under bed componentry. In implementations, the lever arm 46 is received within the receptacle 52 and covered with a cover or cap 54 when the unit 42 is in the stowed position. The cap 54 may also cover the opening of the receptacle 52 after the unit 42 has been moved to the towing position for use to tow a trailer. The cap 54 hides and protects the rotational lever arm 46 and attaches to the bed floor 20 via an attachment interface 55, such as quarter turn knobs or fasteners for example (FIGS. 3-4).

In implementations, the additional receptacle 52 is supported by the floor 20 and/or vehicle frame structure 26 (FIG. 5) underneath the bed floor 20. The receptacle 52 has an open end aligned with the opening 50 and the receptacles 24, 52 are spaced apart and separate from each other.

FIGS. 1-2 show one example position of the lever receptacle opening 50 in relation to the hitch opening 22. In this example, the openings 22, 50 are positioned adjacent to each other in a side by side position across a width of the vehicle 10 to provide the most compact configuration.

In another implementation, a lever receptacle opening 50′ can be centered in the cargo area (FIG. 2) and moved closer to the tailgate 18 so that users can stow/deploy the hitch 40 without the need to climb into the truck bed.

In another implementation, a lever receptacle opening 50″ is positioned within a nested space behind one of the wheel wells 38 and closer to tailgate 18 so users can stow/deploy hitch 40 without the need to climb into the truck bed.

In these alternative examples, the connection interface between the lever 46 and the rotating axle of the unit 42 is reconfigured. Those skilled in the art who have the benefit of this description will be able to determine the reconfiguration of the connection interface that would be best applied for these purposes.

In implementations, the drive mechanism 48 is coupled to a pivot rod or shaft 56 that supports the unit 42 for rotation about an axis A.

In one example, the drive mechanism 48 further comprises a first gear 58 associated with the shaft 56 and a second gear 58 supported by the receptacle 24 to support the unit 42 for rotation between the towing and stowed positions. In one example, the gears are positioned on an opposite end of the shaft from the lever arm.

In one example, the drive mechanism 48 communicates input from the lever arm 46 to the shaft 56 to selectively rotate the unit 42.

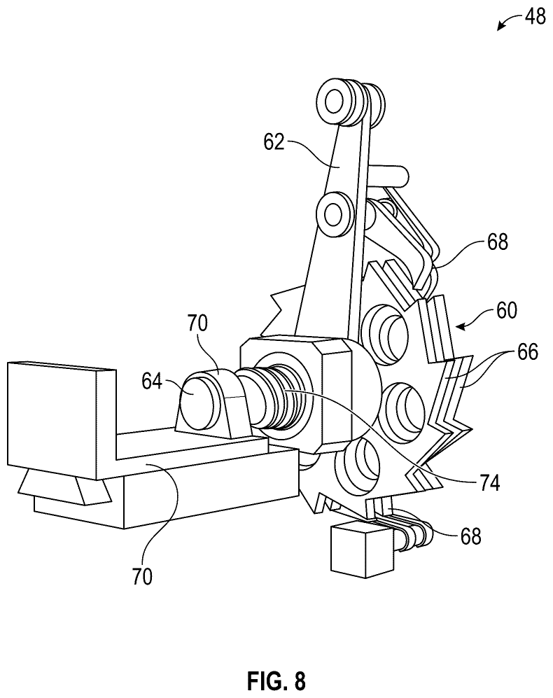

In implementations, the drive mechanism 48 comprises a two-way ratchet assembly. An example of a two-way ratchet assembly 60 is shown in FIG. 8. In this example, the ratchet assembly 60 includes a lever arm 62 coupled to a shaft 64, ratchet gears 66, and pawls 68. In implementations, the shaft and ratchet gears may be associated with the shaft 56 of the unit 42 and the lever arm 62 may comprise or connect to the lever arm 46 associated with the unit 42. In one example, one end of the shaft 64 is rotatably supported in a bearing 70 fixed to base 72. In one example, a resilient member 74, e.g., coil spring, is supported on the shaft 64 and cooperates with the ratchet gears 66, shaft 62, and lever arm 62 to bias the pawls into selective engagement and disengagement with the ratchet gears 66 to allow the shaft 56 to rotate the unit 42 between the towing and stowed position. It should be understood that this is just an example of one type of drive mechanism, many other different types of drive mechanisms could also be used.

Further, in this example, the drive mechanism 48 is manually actuated. However, other types of drive mechanisms could also be used. For example, an electrically powered drive mechanism could also be used. Those skilled in the art who have the benefit of this description will be able to determine what type of drive mechanism would be best applied for these purposes.

In implementations, the unit 42 includes a lock member/mechanism 76 that is moveable between a lock position where the unit 42 is prevented from moving relative to the bed floor 20 and an unlock position where the unit 42 is allowed to move relative to the bed floor 20.

In implementations, the lock mechanism 76 comprises a first set of locking teeth 78 associated with the bed floor 20 and coupled to a pivot shaft 80 extending along one edge of the hitch opening 22, and a first set of locking slots 82 associated with one outer edge of the platform 30, wherein the first set of locking teeth 78 are received within the first set of locking slots 82 when in the lock position.

In implementations, the lock mechanism 76 further comprises a second set of locking teeth 84 associated with the bed floor 20 along an opposite edge of the hitch opening 22 and a second set of locking slots 86 formed in a second outer edge of the platform 30 that is opposite of the first outer edge, wherein the second set of locking teeth 84 are received within the second set of locking slots 86 when in the unit 42 is in a lock position. In one example, the second set of locking teeth 84 are associated with a pivot shaft 90 extending along an opposite edge of the hitch opening 22 from the first pivot shaft 80.

In implementations, the shafts 80, 90 provide points of rotation so the associated teeth can accommodate both engaged and disengaged states with the slots as the unit 42 rotates.

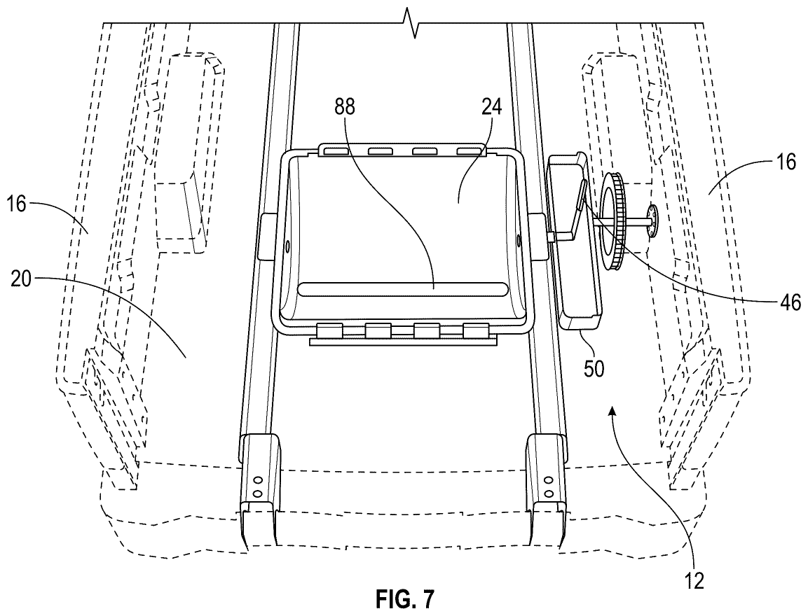

As shown in FIG. 3, in implementations, the receptacle 24 comprises an enclosed tub extending underneath the bed floor 20 from the open end 28. The tub defines an open area or cavity and separates access to under bed componentry. As shown in FIG. 7, in implementations, the enclosed tub includes at least one drain 88. In one example, the drain 88 comprises at least one elongated slot or opening as shown in FIG. 7; however, the drain could comprise multiple openings spaced throughout a bottom of the tub.

FIGS. 5-6 show how the unit 42 mounts directly to the frame 26. In one example, the frame 26 includes at least a pair of longitudinal frame rail members 92 and one or more lateral frame members 94. As shown in FIG. 5, the entire system nestles between the frame rail members 92 without requiring any modification to the frame. Further, the entire system mounts directly to the frame 26 which is necessary to support the loads associated with the hitch 40.

Additionally, the system does not interfere with axle and wheel package areas. The entire system packages without modification to an axle 96 or associated wheel assembly 98 as shown in FIGS. 5-6.

In implementations, the subject disclosure also provides a method that includes selectively moving a trailer hitch between a towing position where the trailer hitch is located in a cargo area above a vehicle bed floor and a stowed position where the trailer hitch is located underneath the vehicle bed floor and hidden from view.

The method can be used with any additional described steps either alone or in any combination thereof.

In one example, the method includes rotating the trailer hitch between the towing position and the stowed position.

In one example, the method includes locking the trailer hitch relative to the vehicle bed floor when trailer hitch is in the towing position, unlocking the trailer hitch, rotating the trailer hitch to the stowed position, and relocking the trailer hitch to the vehicle bed floor.

The subject disclosure provides for design a design solution where a large fifth wheel hitch 40 “disappears” when a user wants uncompromised access and use of the cargo area 12. The design solution comprises a ratcheting rotational execution, where the hitch 40 remains attached to the bed floor 20, and can rotate 180° to stow under a flush floor. As such two states are provided: a deployed state (above floor traditional trailer mode), and a stowed state (where the hitch is hidden beneath the floor). In implementations, the rotational flip of the unit 42 may be accomplished manually by the user who rotates a grab bar or lever arm 46, which is assisted by a ratcheting system 60 that gives the user a mechanical advantage. The lever arm 56 is also nested under a removable floor panel as shown in FIG. 2 to provide an uninterrupted cargo area when in the stowed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A system, comprising:
a bed floor including a hitch opening;
a platform mounted to cover the hitch opening, the platform having a first bed surface and a second bed surface facing opposite the first bed surface; and
a hitch supported on the first bed surface of the platform, wherein the platform and the hitch are selectively movable as a unit between a towing position where the hitch is located in a cargo area above the bed floor and a stowed position where the hitch is located underneath the bed floor.

2. The system of claim 1, wherein the first bed surface is flush with an upper surface of the bed floor when in the towing position and the second bed surface is flush with the upper surface of the bed floor when in the stowed position.

3. The system of claim 1, including an actuator that is selectively controlled to move the unit between the towing position and the stowed position.

4. The system of claim 3, wherein the actuator comprises a lever arm that is coupled to a drive mechanism that interconnects the lever arm and the unit.

5. The system of claim 4, wherein the bed floor includes a first receptacle extending underneath the bed floor, wherein the lever arm is received within the first receptacle and covered with a cap when the unit is in the stowed position.

6. The system of claim 5, including a second receptacle supported by a vehicle frame structure underneath the bed floor and having an open end aligned with the hitch opening, and wherein the second receptacle is spaced apart and separate from the first receptacle.

7. The system of claim 1, wherein the unit is rotatable relative to the bed floor between the towing position and the stowed position.

8. The system of claim 7, including a pivot rod coupled to the unit to support the unit relative to a vehicle frame for pivoting movement between the towing position and the stowed position.

9. The system of claim 1, including at least one lock member that is moveable between a lock position where the unit is prevented from moving relative to the bed floor and an unlock position where the unit is allowed to move relative to the bed floor.

10. The system of claim 9, wherein the at least one lock member comprises at least one locking tooth associated with the bed floor along an edge of the hitch opening and at least one locking slot formed in an outer edge of the platform that receives the at least one locking tooth when in the lock position.

11. The system of claim 10, wherein the at least one locking tooth is coupled for rotation with a shaft supported by the bed floor.

12. A system, comprising:
a bed floor defining a cargo area and including a hitch opening;
a receptacle supported by a vehicle frame underneath the bed floor and having an open end aligned with the hitch opening;
a platform mounted to cover the open end of the receptacle, the platform having a first bed surface and a second bed surface facing opposite the first bed surface; and
a hitch supported on the first bed surface of the platform, wherein the platform and the hitch are selectively movable as a unit between a towing position where the hitch is located in the cargo area and a stowed position where the hitch is received within the receptacle and the second bed surface faces the cargo area.

13. The system of claim 12, wherein the first bed surface is flush with an upper surface of the bed floor when in the towing position and the second bed surface is flush with the upper surface of the bed floor when in the stowed position.

14. The system of claim 12, including a lever arm that is coupled to a drive mechanism that interconnects the lever arm and the unit.

15. The system of claim 14, wherein the unit is rotatable relative to the bed floor between the towing position and the stowed position via selective movement of the lever arm.

16. The system of claim 12, including a first set of locking teeth associated with the bed floor along one edge of the hitch opening and a second set of locking teeth associated with the bed floor along an opposite edge of the hitch opening, and including a first set of locking slots formed in a first outer edge of the platform and a second set of locking slots formed in a second outer edge of the platform that is opposite of the first outer edge, and wherein the first set of locking teeth are received within the first set of locking slots and the second set of locking teeth are received within the second set of locking slots when in the unit is in a lock position.

17. The system of claim 12, wherein the receptacle comprises an enclosed tub extending underneath the bed floor from the open end, and wherein the enclosed tub includes at least one drain opening.

18. A method comprising:
selectively moving a trailer hitch between a towing position where the trailer hitch is located in a cargo area above a vehicle bed floor and a stowed position where the trailer hitch is located underneath the vehicle bed floor and hidden from view.

19. The method of claim 18, including rotating the trailer hitch between the towing position and the stowed position.

20. The method of claim 19, including:
locking the trailer hitch relative to the vehicle bed floor when trailer hitch is in the towing position;
unlocking the trailer hitch;
rotating the trailer hitch to the stowed position; and
relocking the trailer hitch to the vehicle bed floor.
